(19) United States
(12) Patent Application Publication
(10) Pub. No.: US 2017/0115646 A1
(43) Pub. Date: Apr. 27, 2017

(54) SYSTEM AND METHOD FOR GENERATING MATERIAL COMPOSITIONS

(71) Applicant: International Business Machines Corporation, Armonk, NY (US)

(72) Inventors: Yi-Min Chee, Yorktown Heights, NY (US); Ashish Jagmohan, Irvington, NY (US); Pamela N. Luna, HOUSTON, TX (US); Krishna C. Ratakonda, Yorktown Heights, NY (US); Piyawadee Sukaviriya, White Plains, NY (US)

(21) Appl. No.: 15/007,561

(22) Filed: Jan. 27, 2016

Related U.S. Application Data
(63) Continuation of application No. 14/974,595, filed on Dec. 18, 2015.
(60) Provisional application No. 62/246,884, filed on Oct. 27, 2015.

(51) Int. Cl. G05B 19/042; G05B 15/02

(52) U.S. Cl. CPC G05B 19/042; G05B 15/02; G05B 2219/13025

(57) ABSTRACT

According to embodiments, methods, systems, and computer program products are provided for generating material compositions including receiving, by a processor, a plurality of material inputs that collectively form one or more known material compositions, assigning a vector space value to each of the plurality of material inputs, wherein each vector space value is unique for each material input, receiving a first constraint and a second constraint, and generating a transformed material composition based on the vector space value, the first constraint, and the second constraint.

### DOMESTIC PRIORITY

This application is a continuation of U.S. patent application Ser. No. 14/974,595, entitled “SYSTEM AND METHOD FOR GENERATING MATERIAL COMPOSITIONS,” filed Dec. 18, 2015, which claims priority to U.S. Provisional Application No. 62/246,884, entitled “SYSTEM AND METHOD FOR GENERATING MATERIAL COMPOSITIONS,” filed Oct. 27, 2015, the disclosure of which is incorporated by reference herein in its entirety

### BACKGROUND

The present disclosure relates generally to systems and methods for material compositions and, more specifically, to systems and methods for using vector space and neural networks to generate new material compositions.

Generating material compositions is traditionally difficult, particularly when attempting to match various characteristics and/or properties of various materials. For example, expert knowledge in a particular domain (e.g., food, structural materials, etc.) may be required to enable generating new compositions from known materials and/or components. In one example, substitutions in food recipes may be provided based on sensory properties (e.g., taste, smell, feel, etc.) and may rely on experts that are knowledgeable on various properties and pairing or matching such properties with other food ingredients.

Similarly, various combinations may be based on chemical and/or physiochemical properties. In such generation of material compositions, expert input and/or knowledge may be required to enable material compositions that may be viable and/or useful.

### SUMMARY

According to embodiments, methods, systems, and computer program products are provided for generating material compositions including receiving, by a processor, a plurality of material inputs that collectively form one or more known material compositions, assigning a vector space value to each of the plurality of material inputs, wherein each vector space value is unique for each material input, receiving a first constraint and a second constraint, and generating a transformed material composition based on the vector space value, the first constraint, and the second constraint.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a schematic illustration of training or system learning of an artificial neural network in accordance with an embodiment of the present disclosure;

FIG. 2 is a flow process for generating new material compositions in accordance with an embodiment of the present disclosure;

FIG. 3 is a schematic block diagram of a system in accordance with an embodiment of the present disclosure;

FIG. 4A is a flow process in accordance with an embodiment of the present disclosure for learning of material associations; and

FIG. 4B is a flow process in accordance with an embodiment of the present disclosure employing the learned material associations from FIG. 4A to generate a transformed material composition.

### DETAILED DESCRIPTION

Detailed illustrative embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

The terminology used herein is for the purpose of describing particular embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Hereinafter, example embodiments will be described with reference to the attached drawings.

Provided herein are systems, methods, and processes for generating new material compositions based on various constraints. A material composition may be a collection of items, a recipe, a chemical composition, etc., and may be based on the materials that form up the material composition. Various constraints may be imposed or present that limit the ability to form a material composition in a known manner, and thus adjustments and/or substitutions may be required such that a material composition may be formed that is similar and/or based on the original material composition. For example, in one non-limiting embodiment, a constraint may be a legal or regulatory requirement that prohibits the use of a particular material in a material composition. In another situation, a constraint may be a food allergy, wherein a certain ingredient must be eliminated and potentially replaced or substituted for in a recipe. Other constraints may include lack of a particular material in an inventory and thus a substitution must be found based on what is available.

As provide herein, computing systems may be configured to learn from a knowledge base and take an input, a constraint, and a list of materials to generate a new material composition. For example, with respect to a food recipe, a user may wish to modify a recipe to change the cuisine or may want to make a recipe without a particular ingredient due to a dietary restriction or based on available ingredients. The user may input the desired recipe, input the available ingredients, and the system will process and generate, based on a knowledge base, a new recipe.

Systems may be configured in various forms to achieve the processes described herein. In some embodiments an artificial neural network and associated systems may be used. In other embodiments, a computing system using co-occurrence matrices may be used. Other configurations and computing system may be used without departing from the scope of the present disclosure. The following is a description of an artificial neural network that may be used to perform processes as described herein.

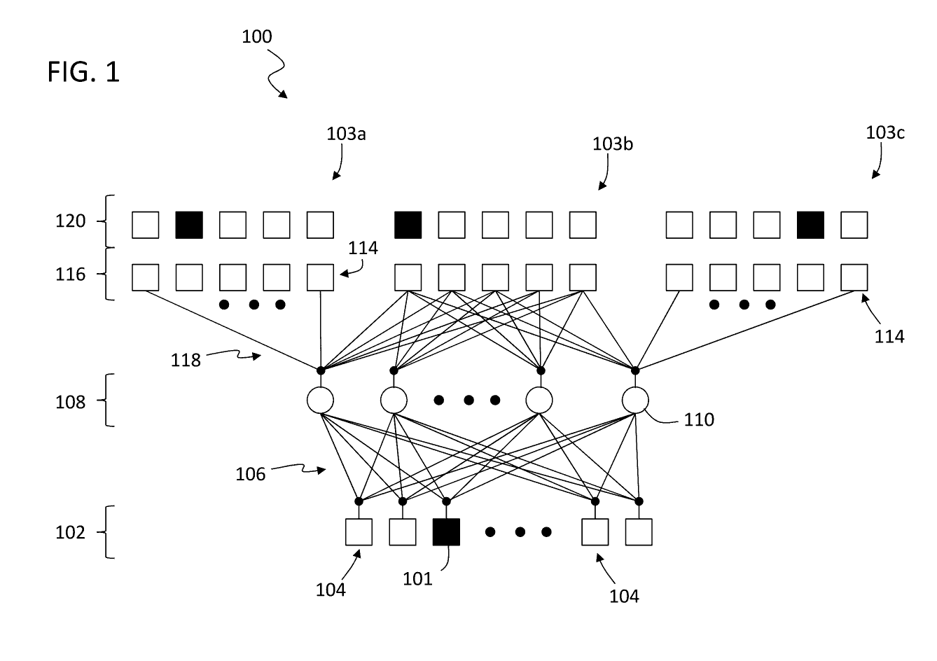

One configuration of an artificial neural network is provided including an input layer, a middle, hidden layer, and an output layer. In such a system, training of the system may be performed to teach and configure the system to generate desired results, i.e., generate new material compositions based on various inputs including constraints and a knowledge base. With reference to FIG. 1, a schematic illustration of an artificial neural network 100 that may be used in accordance with an embodiment of the present disclosure is shown.

The artificial neural network 100 is shown as an algorithm process and/or computing system. The artificial neural network 100 includes an input layer 102 that includes one or more input nodes 104 which may be used for training. In one example embodiment, using external training, the input nodes 104 are configured to provide random, fixed input values over a number of input connections 106. The input connections 106 are configured to connect the input nodes 104 of the input layer 102 with nodes of a middle layer 108. The middle layer 108 may be configured as a hidden or embedding layer, as described herein. The learning of the artificial neural network 100 is performed within the middle layer 108.

The middle layer 108 includes a number of middle layer nodes 110. The middle layer 108 may receive inputs from the input layer 102 to perform learning, training, weighting, and processing, and may provide outputs therefrom. In some embodiments, each middle layer node 110 may be a real number.

One or more of the middle layer nodes 110 of the middle layer 108 are connected to one or more output nodes 114 of an output layer 116 through output connections 118. In one example, the output connections 118 may be configured as trained weights, i.e., the output connections 118 will be adjusted such that the output from the middle layer 108 may be controlled by the output connections 118, and a desired result may be achieved at the output layer 116. For example, the output layer 116 may be configured to match or correspond to a target layer 120.

In some embodiments a weighted sum of the middle layer nodes 110 may be a linear weighting and in other embodiments, the weighting may be non-linear. As a result, the output layer 116 is a trained or controlled layer with respect to weighting and combining such that the artificial neural network 100 can compute desired results, even with unknown inputs. That is, in some embodiment, given an unknown input at input layer 102, a desired result may be achieved at output layer 116.

For example, the artificial neural network 100 may be trained and configured with an output layer 116 that is controlled for generating outputs that when a known input is supplied at the input layer 102, a known output is generated at the output layer 116. Based on a number of training processes like this, the configuration of the middle layer nodes 110 and the output connections 118 between the middle layer 108 and the output layer 116 may be set. Then, when a new input is supplied to the input layer 102, the output at the output layer 116 may be robust, reliable, and accurate.

As such, in sum, the input layer 102 may receive some information to be identified or classified, the input layer 102 transmits information to the middle layer 108, and the middle layer 108 supplies data or information that is identified or classified as the output in the output layer 116.

Referring still to FIG. 1, the input layer 102 may include information regarding a single input material 101, indicated by a single node of the input layer 102, that is part of one or more known material compositions indicated in target layer 120. For example, the target layer 120 may include one or more known materials (e.g., known target materials 103a, 103b, 103c) from a composition that also includes the input material 101. Because the input material 101 and the target materials 103a, 103b, 103c, are known as materials of a single, known material composition, the individual materials 101, 103a, 103b, 103c may be referred to herein collectively (e.g., the known material composition) as a “training material composition.”

The artificial neural network 100 is configured to learn from various external information in the target layer 120 and associate the information with the input material 101 that is indicated in the input layer 102. That is, based on a single input material 101, the middle layer 108 is configured to generate a desired result in the output layer 116, such as identifying and correlating the input material 101 with the other materials of one or more material compositions that include the input material 101. That is, the target layer 120 includes one or more target materials 103a, 103b, 103c are other materials in a material composition that also includes input material 101. Accordingly, the artificial neural network 100 can learn associations between various materials of material compositions.

The middle layer 108 may be a low-dimensional neural network layer and the output layer 116 may be a non-linear function of node values of the middle layer 108. Model learning may be achieved by tuning parameters of the artificial neural network 100 such that the output nodes 114 of the output layer 116 correlate the input material 101 with the target materials 103a, 103b, 103c of the target layer 120. That is, the target layer 120 includes one or more materials 103a, 103b, 103c of a material composition that also includes the input material 101 input at the input layer 102. The artificial neural network 100 is configured to adjust values within the middle layer 108 and/or the weights associated with the connections 106, 118, such that a particular value is generated at the output layer 116.

When the output layer 116 and the target layer 120 are close, the artificial neural network 100 learns to identify other materials (e.g., target materials 103a, 103b, 103c) in the same material composition for the input material 101. For example, each of the middle layer nodes 110 may be represented as a real-valued number, and the list of values of the middle layer 108 may be used as a vector value in a vector space. When a number of input materials 101 are learned, the artificial neural network 100 may be configured to make substitutions of a known input material 101 by comparing the vector space of different middle layers 108 to substitute one known material for another, based on, for example, a difference (e.g., small difference) between two vector spaces of the middle layer 108.

As noted, the output layer 116 is a function of material vector space values, and thus, two materials which often occur in similar material compositions, e.g., material compositions having similar materials that form the composition, may have similar material vector space values. As such, embodiments provided herein provide an artificial neural network that may learn material pairing and substitutability based on material vector space values. That is, if two materials have very close or similar vector space values, but seldom appear together in training material compositions, it may be assumed that the materials are similar, and thus may be substitutable. Similarly, if two materials have very close or similar vector space values, and are seen to appear together in some training material compositions, it may be assumed that the materials are suitable for pairing. However, if two materials have a large difference in material vector space values, it may be assumed that the two materials are not similar and cannot be substitutes. The difference may be a predefined difference, such that the predefined difference defines what “similar” materials are, i.e., the difference in vector space values that enables a substitution of one material for another material and/or pairing of one material with another material or material(s).

In one example, with a single input material 101 in the input layer 102, and known target materials 103a, 103b, 103c (e.g., various other materials in a known material composition that includes the input material 101) in the target layer 120, the artificial neural network 100 may learn which connection weights within and through the middle layer 108 provide or generate the designed alignment and matching between the output layer 116 and the target layer 120. In one non-limiting embodiment, each of the input material 101 and the target materials 103a, 103b, 103c, are each represented using one-hot vectors of length equal to the number of unique materials in the material composition or all material compositions (i.e., the scope of all materials in the space of material compositions).

As shown, the middle layer 108 is formed of a plurality of middle layer nodes 110. The various middle layer nodes 110, and the weights associated with the connections 106, 118, may be configured to connect the input layer 102 with the output layer 116. In one non-limiting embodiment, each of the middle layer nodes 110 is a real value (e.g., negative, positive, decimal, etc.). Thus, as noted, the middle layer 108 may be represented by a unique material vector space value for each unique input material 101. In this case, the values of the middle layer nodes 110 are a function of the values at the input layer 102 and a numerical weight associated with each input connection 106 connecting the input layer 102 and the middle layer 108. The values of the output layer nodes 116 are a function of the values at the middle layer 108 and a numerical weight associated with each output connection 118 connecting the middle layer 108 and the output layer 116.

In operation for training, one input material 101 is provided at the input layer 102. For example, one node of the input layer 102 may be assigned a value of “1” and all other nodes of the input layer 102 may be assigned a value of “0.” In such a configuration, the input layer 102 represents a particular input material 101. There may be i nodes in the input layer 102. Similarly, a number of other materials from a material composition containing input material 101 are provided at the target layer 120 (e.g., target materials 103a, 103b, 103c). Each target material 103a, 103b, 103c is represented by a sub-group of nodes in the target layer 116. For example, each target material 103a, 103b, 103c may be indicated by assigning a single node in the sub-group a value of “1,” while the other nodes in the sub-group are assigned a value of “O.”

The middle layer 108 may include z nodes, and thus z real values in the middle layer 108. Based on a combination of connections to and/or within the middle layer 108, a value may be formed in the output layer 116. The goal of training is to have the value generated at the output layer 116 match a value of the target layer 120. During training, the difference between the value of the output layer 116 and the value of the target layer 120 is measured and a distance or difference may be determined. Training may be performed (e.g., adjustment of the weights of the input connections 106 and the output connection 118) such that convergence is achieved between the value of the output layer 116 and the value of the target layer 120. The process may be repeated for i input materials, wherein a material composition includes i materials. That is, the artificial neural network 100 may learn the weighting for each material that comprises a single material composition, and this may be repeated for any number of material compositions. Accordingly, a training process may train the artificial neural network 100 using r material compositions, with each material composition having i materials.

Once trained, each material that may be input in the input layer 102 (i.e., each input value that represents a particular material of a material composition) will have an associated and unique configuration or form of the middle layer 108. That is, each individual material will have an associated unique vector space value in the middle layer 108.

As noted, similar materials (with respect to similarities between properties, characteristics, etc.) may have similar, although different, configurations or forms of the middle layer 108. That is, two similar input materials 101 may have vector space values that are close or similar. Thus, two materials that are similar may have similar configurations of the middle layer 108 such that one material may be substituted for another, based on the similarity of the two configurations of the middle layer 108. For example, the values of the output layer 116 of two different, but similar, input materials 101 may be very close (e.g., a small difference between the values) such that one value may be substituted for another and produce similar output layers 116 and thus one material may be a potential substitute for another. To make this comparison, the material vector space values of the middle layer 108 for each material is compared, and if the two values are within a predetermined value or difference, it is determined that the materials are similar and potentially substitutable and/or pairable. From this, with a particular input and various constraints, adjustments to known material compositions may be made by identifying and providing substitutes for one or more materials of the original material composition.

The learning that is imposed in the system may be based on one or more knowledge bases, including but not limited to expert knowledge, recorded knowledge, internet databases, user input (e.g., trial and error and/or user preferences), etc. The knowledge base may be used to generate a comprehensive middle layer vector space value, and also enable the best pairing and/or substitution identification by assisting in determining an adequate and/or defined difference that is used when comparing various material vector space values.

Accordingly, a system and method for providing material composition transformations may be provided by learning input-material configurations in a vector space, such as the middle layer 108 of the artificial neural network 100. Once the middle layer 108 is configured for various materials, the vector space values learned for individual input materials 101 may be used to generate new material compositions that have variations from an original material composition. For example, because the artificial neural network 100 may be able to determine materials that have similar values in the middle layer 108, a transformation process providing a substitution or variation of a material of a material composition may be generated based on one or more constraints and comparison of material vector space values within the middle layer of the artificial neural network 100.

The substitutions may be based on learning from a plurality of known target materials/values, i.e., information from a knowledge base (e.g., lists of known material compositions, know correlations between materials, etc.). For example, referring again to FIG. 1, a target layer 120 may include one or more known materials 103a, 103b, 103c, and may be used such that the artificial neural network 100 may learn what materials are known to be associated with the input material 101. For example, a single input material 101 may be included and/or associated with multiple known target materials 103a, 103b, 103c (which may be repeated for multiple known material compositions at target layer 120), and thus, knowing the other materials in the known material composition (e.g., target materials 103a, 103b, 103c), the artificial neural network 100 may learn associations, not just for certain input materials, but also between various materials, i.e., possible substitutions, combinations, complementary materials, pairings, etc.

From this, the artificial neural network 100, and systems and processes as described herein, may be used to modify material compositions by substituting one or more materials for one or more other materials or may be used to generate new and/or unique new material compositions by providing pairings between known materials.

In various embodiments, as will be appreciated by those of skill in the art, the learning process and later computing processes (e.g., material substituting and/or pairing) may be employed using a vector representation framework. The vector representation framework may utilize material combination patterns to build an embedded material vector model for materials. Further, the system may include a composition transformation framework. The composition transformation framework may utilize learned material vectors to determine a suitable substitution in a material composition. Thus, embodiments provided herein may learn data-driven material combinations and substitutions without requiring domain expert input. Further, embodiments provided herein can be used to drive a variety of transformations including, but not limited, material substitution, material composition formulation, material composition translation to different types of material composition, etc.

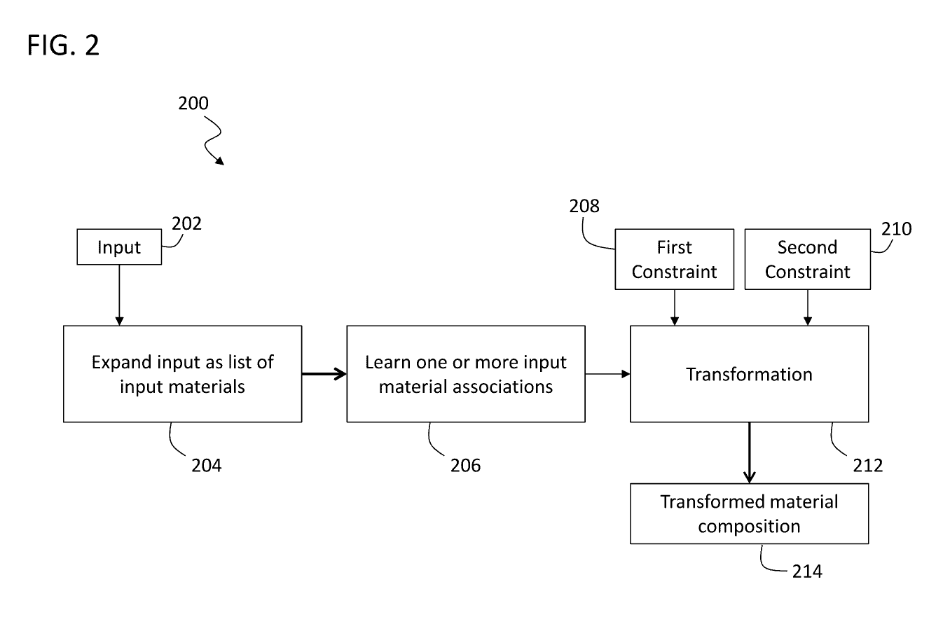

Turning now to FIG. 2, a non-limiting example of material composition generation or transformation in accordance with an embodiment of the present disclosure is shown. In this embodiment, the process is used to modify a known material composition, although the process may start with only a goal, desired result, or even just a single input material to generate a new material composition.

A flow process 200 is shown, wherein a material composition input is provided into a computing system as shown at block 202, such as an artificial neural network 100 shown and described in FIG. 1. The material composition input may be a recipe or other listing of materials (e.g., ingredients, materials, components, subcomponents, etc. and/or actions, steps, etc.) that are combined to achieve a particular result, e.g., ingredients and actions that are taken to prepare a meal. The material composition input at block 202 may be one or more known sets or examples of various material compositions. That is, the input may be a known value or values.

At block 204, the process may include expanding or extracting information from the input into a list of materials. For example, each material and/or action may be extracted to form a distinct value or data point that comprises a subpart of the input at block 202. For example, a plurality of values of known input materials may be generated, and learning as described with respect FIG. 1 may be performed at block 206. That is, each input material be learned to have a specific configuration of the middle layer, e.g., a material vector space value, as described above. As such, at block 304, the input information may be deconstructed into a plurality of input material(s) that are used for learning as described above.

From the extracted input information, the system may learn one or more associations between input materials, as shown at block 206 (e.g., the learning process described above with respect to FIG. 1). For example, vector learning and/or neural network learning may be performed to assign or program the computing system to associate certain connections within the middle layer, i.e., assign or associate specific material vector space values with specific input materials. As such, in some non-limiting embodiments, an input can be associated with a particular output.

In various embodiments, the process 200 may include an artificial neural network, as described above. In such embodiments, the middle layer may be embedded with connections (and thus values) that are unique to each material that the network is trained to learn, and thus material vector space values may be determined. In other embodiments, the process may include a co-occurrence matrix wherein co-occurrence matrices for input materials may be determined and material vector space values may be obtained via matrix factorization. Thus, at block 206, a scope of all relationships of materials that form a plurality of material compositions may be known.

At blocks 208 and 210 a first constraint and a second constraint, respectively, may be provided. The first and second constraints may be limitations or restrictions that are applied when the process 200 is used to generate a transformed material composition. For example, a first constraint may be an input material composition (e.g., one of the material compositions provided in the input process of block 202). A second constraint may be a limitation that prevents the initial list of materials from being used entirely to form the material composition provided at block 208. That is, the second constraint of block 210 may apply a limitation upon the first constraint such that a substitution, pairing, and/or other transformation must be applied to the material composition of the first constraint. The process 200 may then perform a transformation at block 212 and output a transformed material composition at block 214.

For example, a first constraint may be a list of ten materials that form a material composition to be modified, and the second constraint may be a requirement that three of the materials are not available and thus substitutes for those three materials is required. As will be appreciated by those of skill in the art, any number of constraints and any types of constrains may be imposed to generate a transformed material composition.

Based on the learning of block 206 and the constraints input at blocks 208, 210, a transformation or modification may be performed at block 212. For example, at block 212, a list of materials of a material composition may be provided as a first constraint (block 208) and a second constraint may be provided to limit or require the list of material to be changed (block 210) using the associations (e.g., learning) from block 206. That is, for example, an unavailable material identified in the second constraint (block 210) may be used to prompt the system to modify the list of materials from the first constraint (block 208) based on the learning and material associations (block 206) to find a substitution for the restricted material and transform (block 212) the material composition (block 208) into a transformed material composition (block 214).

After the transformation (block 212), the process 200 may output a transformed material composition at block 214. The modified material composition, in some embodiments, may be a material composition that includes materials dictated by the constraints imposed at blocks 208, 210, and by making substitutions based on the learning at block 206.

The process of substitution may be based on determining a material that has a vector space value of the middle layer that is within a specific, predefined distance of another material vector space value. For example, a first material may have a first vector space value and the first material may be desired to be replaced or a substitution is to be found, e.g. based on a constraint. A second material may be found that is a replacement or substitute of the first material. The second material may have a second vector space value. The second vector space value may be within a predetermined distance of the first value, and thus the distance or difference between the two vector space values may be the basis for selecting the second material as a substitution for the first material.

Further, the systems and processes provided herein may employ a substitution history to determine a substitution in the future. For example, as part of the inputs into the learning, a sequence of historical transformations may be used as an input, from which potential substitutions may be derived and used as an input, such that a first material and a known substitution may have similar vector space values generated during the training and/or learning of the system. Thus, a substitution history may influence the learning to improve (lower) the distance between two known substitutes, i.e., the vector space values of the two materials may be made to be similar.

Further, characteristics of the materials of material compositions may be used to improve the closeness (i.e., minimize the distance) of two materials with respect to the distance between vector space values. For example, two materials may have similar chemical compositions, material properties, strengths, colors, shape, smell, tastes, etc. With known similarities in material characteristic, the information may be used to assist in the learning and generation of middle layer values such that two materials may have similar, yet different, vector space values.

Furthermore, material co-occurrences may be used to influence learning and vector space values. For example, if two materials regularly appear in material compositions together, this fact may influence how close the vector space values of two materials are. In some non-limiting embodiments, this information may influence material pairing rather than material substitution.

In some embodiments, a substitution history, characteristics of the materials, and/or material co-occurrences may be used separately and/or in addition to the vector space value generation, in order to influence the material transformation 212. For example, to find a substitute for a first material in a material composition input 208, a second material may be selected such that: (1) the second material has a vector space value close to the vector space value of the first material; and (2) the second material has characteristics which are close to the first material and/or the second material is a known potential substitute of the first material and/or the second material has vector space values indicating that it well-suited to co-occur with some of the other materials in the material composition 208 which are to be retained in the transformed composition 214.

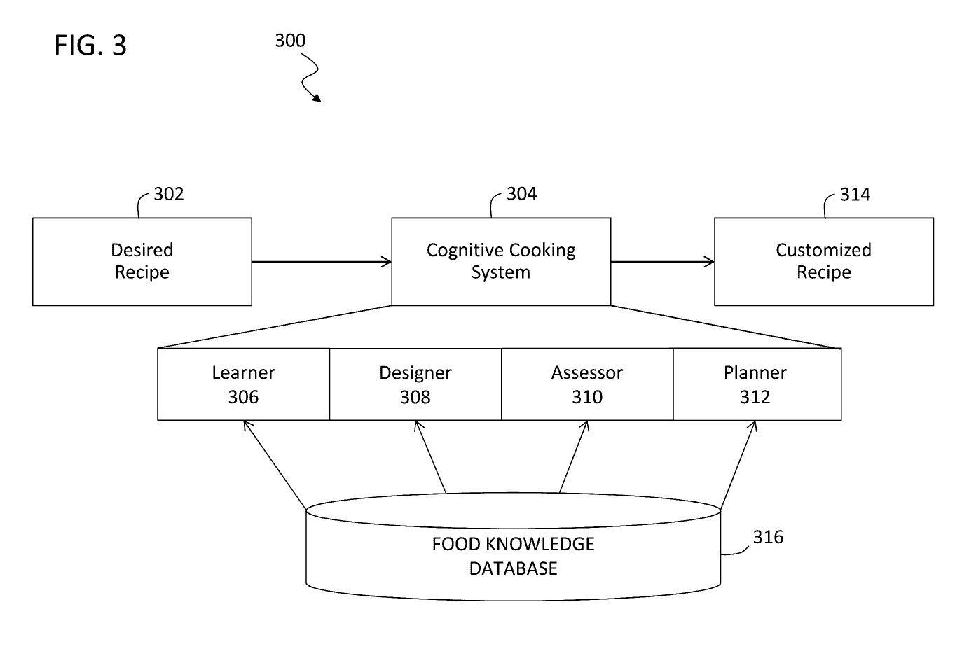

Turning now to FIG. 3, one example embodiment of the present disclosure is shown. In FIG. 3, the above described systems and processes may be employed for cooking and recipe selection. That is, based on a food knowledge database, a cognitive cooking system may be implemented to generate a recipe based on known, available ingredients, even if the desired recipe calls for something not available.

For example, as shown in FIG. 3, a system process 300 may have a desired recipe input 302. The desired recipe may be a dish or other meal that a user may wish to make. In other embodiments, the input may be a particular cuisine type, a specific ingredient, a list of ingredients available, desired nutritional properties, etc. The desired recipe input 302 may be input into a cognitive cooking system 304.

The cognitive cooking system 304 may be similar to the systems and processes described above, and may include a trained system or artificial neural network that may be configured to make substitutions and/or pairings of various food ingredients or propose new combinations based on known information. For example, the cognitive cooking system 304 may include a learner 306 that includes a list of ingredients available to the user and the associations within a middle layer (e.g., as described above). For example, the learner 306 may have information input from a food knowledge database 316 to generate a plurality of ingredient vector space values (similar to the process described above).

Based on the known available ingredients and the original desired recipe (input at block 302), the cognitive cooking system 304 may generate new ingredient combinations at designer 308. The designer 308 may generate a plurality of potential ingredient combinations based on the closeness of vector space values of various ingredients. That is, for example, the designer 308 may generate a list of one or more substitutions and thus generate substitute recipes or combinations.

The cognitive cooking system 304 may then assess the potential candidate recipes using an assessor 310. For example, for each new ingredient combination, the cognitive cooking system 304 may be configured to compute surprise, pleasantness, chemical pairs, etc. That is, the cognitive cooking system 304 may compare overall closeness of vector space values of new ingredient combinations with the original recipe 302 using the vector space value deviance as an indication of various parameters. The new ingredient combinations may then be scored and ranked (e.g., based on the difference of the total vector space value against the target original recipe of input 302), and various associated actions or steps may be considered to form interim modified recipes.

The cognitive cooking system 304 may also include a planner 312 that is configured to select one of the interim modified recipes generated by the designer 308. For example, from the new ingredient combinations assessed by the assessor 310, the planner 312 may select or identify an interim modified recipe that is closest or most similar to the originally desired recipe based on comparing one or more vector space values with the originally desired recipe. In some embodiments, the planner may further compute appropriate ingredients and proportions determined by the other components of the cognitive cooking system 304 such that a recipe (i.e., ingredients plus steps) may be provided as a customized or transformed recipe 314.

As shown, the cognitive cooking system 304, and the components thereof, may have a food knowledge database 316 associated therewith. The food knowledge database 316 may include various information including a database of potential ingredients (including vector space values) and information related therewith, including, but not limited to, surprise, pleasantness, chemical composition, and other information that may be determined by experts, obtained from other databases (e.g., websites, cookbooks, etc.). The information considered in the food knowledge database may be used to generate the material vector space values of each ingredient (e.g., the food knowledge database may comprise all of the ingredients and associated recipes that are used for training an artificial neural network).

Although the specific example provided in FIG. 3 is directed to food and ingredients in recipes, those of skill in the art will appreciate that the processes, methods, and systems provided herein may be used for any type of material composition. That is, embodiments provided herein may be used to generate new compositions by employing active learning networks and substitutions as described herein. As such, any type of material may be provided with a vector space value, and multiple materials may be combined and/or substituted to generate new material compositions based on the vector space values.

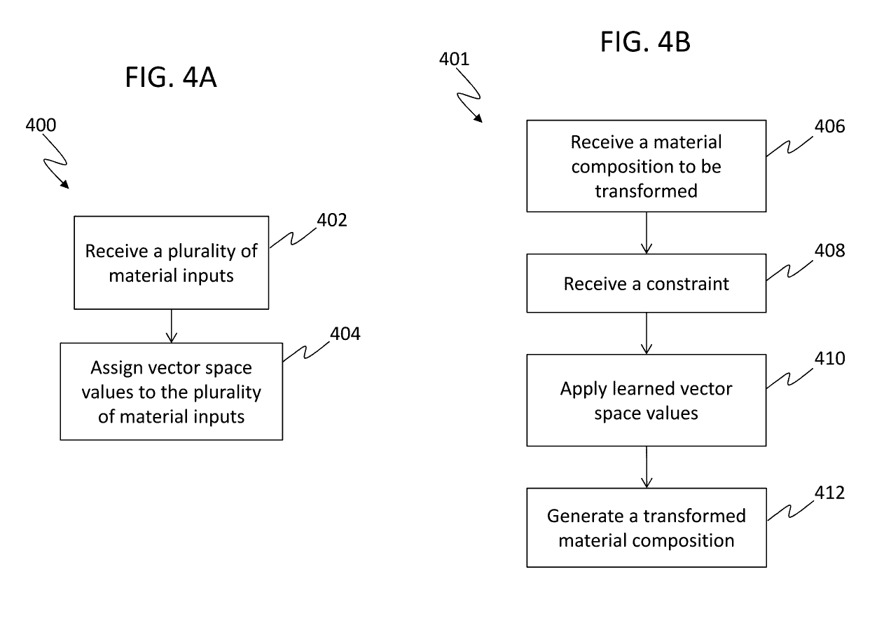

Turning now to FIGS. 4A and 4B, flow processes 400 and 401 in accordance with an embodiment of the present disclosure is shown. The flow process 400 may be a training process and flow process 401 may be a material transformation process.

In the training process 400 (FIG. 4A), a plurality of material inputs that form one or more material compositions may be used to train a system or network, such as an artificial neural network. As such, at block 402, a system may receive a plurality of material inputs, as shown at block 402. At block 404, each of the material inputs may be assigned a vector space value based on a correlation or association with each of the other materials that make up the one or more material compositions. The vector space values may be values that represent and are associated with a particular input material. Two input materials that are similar (based on any number of parameters) may have vector space values that are similar or close to each other (e.g., potential substitutes). Two materials that are different but appear together in material compositions regularly may have vector space values that are close or similar to each other (e.g., potential pairings). Two materials that are different and don't appear in material compositions together may have vector space values that are far apart or different from each other.

With the learning performed in flow process 400, a flow process 401 may be performed to generate a transformed material composition (FIG. 4B). At block 406, a material composition to be transformed may be provided. The material composition to be transformed may include a list of materials that form a material composition. In other embodiments, a first constraint may be provided at block 406. For example, a first constraint may be a list of materials that don't form a known material composition (e.g., the materials input at block 406 may be random and/or selected based on any criteria but may not form a known composition). For example, the input at block 406 may be a list of ingredients a user has available to them, and they don't know what they want to make with the available ingredients.

At block 408, a constraint (or second constrained) may be provided. The constraint provided at block 408 may be an indication of one of the materials of the material composition provided at block 406 is not available. The constraint provided at block 408 may be a limitation on price of materials such that one of the materials of the input material composition should be replaced. The constraint provided at block 408 may be a new material that a user wants to incorporate into the material composition input at block 406. As will be appreciated by those of skill in the art, the constraint (or second constraint) received at block 408 may be any type of constraint that may be applied or applicable to the materials of the material composition provided at block 406.

In some non-limiting embodiments, the constraint provided at block 408 may include a maximum difference between two material vector space values. In some embodiments a first predetermined difference may be used for substitutions, i.e., a first maximum difference may define how different two material vector space values may be such that a substitution may be made. A second predetermined difference may be used for pairing, i.e., a second maximum difference may define how different two material vector space values may be such that two materials are paired and combined in a material composition. For example, if the materials are food ingredients, a first maximum difference may be used to enable substitution of different types of cheeses, and a second maximum difference may be used to enable pairing of cheese and bread for a grilled cheese. However, for example, something like pineapple may have a vector space value that is greater than both the first maximum difference and the second maximum difference, and thus the system would not recommend putting pineapple on a grilled cheese.

Other constraints received at block 408 may include a list of the materials that are available to a user, and thus if a specific material composition is desired (e.g., material composition provided at block 406), but not all materials are present, the system may propose what available materials (received at block 408) may be used to achieve something similar to the original desired material composition. Further, constraints may include material costs, legal or regulatory restrictions, time constraints, user or other personal preferences, etc.

With the material composition to be transformed (block 406) and the constraints (block 408), the learning from flow process 400 (FIG. 4A) may be applied at block 410. That is, the learning models and associations of materials for various material compositions are applied. The associations or mapping of each material to a signature vector in a vector-space may be applied to the materials dictated by block 406 and 408.

From this, a transformed material composition may be generated, as shown at block 412. In some embodiments, the transformed material composition may be a version of the material composition received at block 406. That is, per the constraints received at block 408 and the known material mapping/associations, a transformed material composition may include most of the same materials as the original material composition but may have one or two materials substituted for other materials. In other embodiments, the transformed material composition may be a subset of the original materials of the material composition input (e.g., if the original input was just a list of materials not known to form a known material composition). In some embodiments, the transformed material composition may be a synthesis of materials responsive to the vector signatures of the materials provided at the input.

The substitutions, modifications, and/or transformations provided herein may be performed responsive to input constraints on one or more of composition cost, regulatory constraints, and/or composition function. That is, in various embodiments, the constraints may not only be limited to available resources, but rather, any number of factors may be used to influence the system to perform and select a substitution for a material. For example, with respect to food recipes, allergies of a may be a constraint, limiting various recipes—yet a desire to have something similar to the food that the user is allergic to. In the world of structural materials, it may be governed by law that certain materials or compositions may not be able to be used. As such, a criteria or constraint may be based on such considerations.

Further, in some embodiments, the raw materials used in composition generation are provided during training as encrypted values, or are otherwise concealed.

As described above, the compositions may be food recipes, and the materials may be ingredients (or food). In such instances, the composition may be additionally responsive to cuisine type, recipe type, and dietary restrictions, among other requirements.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A computer implemented method to generate a modified material composition, the method comprising:
receiving, by a processor, a plurality of material inputs that collectively form one or more known material compositions;
assigning a vector space value to each of the plurality of material inputs, wherein each vector space value is unique for each material input;
receiving a first constraint and a second constraint; and
generating a transformed material composition based on the vector space values, the first constraint, and the second constraint.

2. The computer implemented method of claim 1, wherein the first constraint is an input material composition, the method further comprising substituting a first material with a second material in the input material composition based on a difference between a first vector space value of the first material and a second vector space value of the second material, the transformed material composition including the second material.

3. The computer implemented method of claim 2, wherein the difference between the first vector space value and the second vector space value is below a predetermined value.

4. The computer implemented method of claim 1, further comprising training an artificial neural network to learn the vector space values of the plurality of material inputs.

5. The computer implemented method of claim 4, wherein a step of the training comprises an input material, one or more known target materials, and an output that is learned that associates the input material with the one or more known target materials.

6. The computer implemented method of claim 1, wherein the second constraint is at least one of material cost, regulatory restriction, or material function.

7. The computer implemented method of claim 1, wherein the plurality of material inputs are food ingredients, the known material compositions are food recipes, and the transformed material composition is a food recipe.

8. The computer implemented method of claim 7, wherein the first constraint is an input recipe and the second constraint is at least one of cuisine type, recipe type, or dietary restriction to be used to transform the input recipe.
